(19) United States
(12) Patent Application Publication
(10) Pub. No.: US 2025/0289013 A1
(43) Pub. Date: Sep. 18, 2025

(54) SPRAYING DEVICE AND POOL

(71) Applicant: Dongguan Polyfilm Plastic Products Company Limited, Guan City (CN)

(72) Inventors: Jin Haun JIN, Guan City (CN); Michael YU, Guan City (CN)

(21) Appl. No.: 18/607,203

(22) Filed: Mar. 15, 2024

(51) Int. Cl. B05B 7/00; E04H 4/12

(52) U.S. Cl. CPC B05B 7/0087; E04H 4/12

(57) ABSTRACT

The present disclosure relates to a spraying device including a Venturi tube. Two ends of the Venturi tube is provided with a first opening and a second opening respectively, and a sidewall of the Venturi tube is provided with an air vent. The Venturi tube has a throat portion arranged between the first opening and the second opening, and a tube diameter of the throat portion is less than an opening diameter of the first opening and less than an opening diameter of the second opening. The first opening is used for communicating with a water supply, and the air vent is used for communicating with external atmosphere. The spraying device and a pool including the same can produce spraying effects meeting requirements.

### TECHNICAL FIELD

The present disclosure relates to the technical field of pool accessories, and in particular, to a spraying device and a pool.

### BACKGROUND

In recent years, ground pools or other pool-type water playing devices have become more and more popular among adults and children, especially pools with spraying devices, which, on the one hand, can provide a user with a variety of water playing experience and improve fun, and on the other hand, can also increase oxygen content of water in the pool, enable a water flow to be purified in a circulating spraying process, and can also provide a massage function for the user through a water jet. However, spraying effects of spraying devices currently available on the market are varied and often cannot achieve required spraying effects.

### SUMMARY

Based on this, there is a need to provide a spraying device and a pool. The spraying device and the pool can produce spraying effects meeting requirements.

In an aspect, the present disclosure provides a spraying device including a Venturi tube. Two ends of the Venturi tube is provided with a first opening and a second opening respectively, and a sidewall of the Venturi tube is provided with an air vent. The Venturi tube has a throat portion arranged between the first opening and the second opening, and a tube diameter of the throat portion is less than an opening diameter of the first opening and less than an opening diameter of the second opening. The first opening is used for communicating with a water supply, and the air vent is used for communicating with external atmosphere.

When the above spraying device is in use, water may be introduced into the Venturi tube through the first opening, and a water flow flows along a direction from the first opening to the second opening. Moreover, when the water flow flows through the throat portion, it has an increased flow velocity since the tube diameter shrinks. As a result, the water flow forms a negative pressure near the throat portion, so that outside air enters the Venturi tube through the air vent under the negative pressure, is mixed with the water flow, and continues to flow to the second opening. Since the opening diameter of the second opening is greater than the tube diameter of the throat portion, a water-air mixture is finally sprayed out of the second opening in a shape of a high-speed jet, so as to form water mist with a better atomization effect or an air-water mixture with a higher flow rate in the pool body to provide a user with a variety of water playing experience and an impact massage effect, which can increase oxygen content of pool water and improve purity of the water at the same time, making a filtration circulation effect of the water more obvious. At the same time, the faster flow of the water in the throat portion can also prevent formation of scale in the Venturi tube to some extent.

In an embodiment, the air vent is arranged corresponding to the throat portion or the air vent is arranged corresponding to a part of the Venturi tube between the throat portion and the second opening.

In an embodiment, the Venturi tube further includes a shrink tube portion communicated with the throat portion. An end of the shrink tube portion away from the throat portion is provided with the first opening.

In an embodiment, the Venturi tube includes: a first tube section including a shrink tube portion and a throat portion connected with each other, an end of the shrink tube portion away from the throat portion being provided with the first opening, an inner diameter of the shrink tube portion gradually decreasing from the first opening to the throat portion; and a second tube section, an inner diameter of the second tube section being greater than that of the throat portion, an end of the second tube section being provided with the second opening, a sidewall of the second tube section being provided with the air vent, an end of the second tube section away from the second opening being provided with a mounting port. An end of the first tube section having the throat portion is inserted into and fixed to the second tube section, and the first tube section is communicated with the second tube section through the throat portion.

In an embodiment, the spraying device further includes: a spraying main body having an air inlet, a water inlet, a spraying port, and a mounting cavity. The air inlet, the water inlet, and the spraying port ae all communicated with the mounting cavity. The Venturi tube is arranged in the mounting cavity, the water inlet is communicated with the water supply and the first opening, the air inlet is communicated with the external atmosphere and the air vent, and the spraying port is communicated with the second opening.

In an embodiment, the spraying device further includes a first sealing element arranged between a cavity wall of the mounting cavity and an outer wall of the Venturi tube.

In an embodiment, the spraying device further includes an inlet valve arranged at the air inlet to prevent outflow of water in the Venturi tube through the air inlet.

In an embodiment, the spraying device further includes a dust cover arranged at the air inlet to prevent entry of dust into the spraying main body through the air inlet.

In an embodiment, the spraying device further includes an inlet valve and a mounting support. The mounting support is of a hollow tubular structure, an end of the hollow tubular structure is communicated with the air vent, the inlet valve is arranged in the hollow tubular structure to prevent outflow of water in the Venturi tube through the air inlet.

In an embodiment, the spraying device further includes a dust cover arranged at an end of the hollow tubular structure away from the air vent.

In an embodiment, the spraying device further includes a second sealing element arranged between the mounting support and the Venturi tube.

In an embodiment, the spraying device further includes a spraying cover provided with at least one spraying hole. The spraying cover covers the spraying port.

In an embodiment, the spraying cover is detachably connected to the spraying main body.

In an embodiment, the spraying device further includes a third sealing element arranged between the spraying cover and the spraying main body.

In an embodiment, the spraying device further includes a spraying lid configured to detachably cover the spraying cover.

In another aspect, the present disclosure provides a pool including a pool body and the spraying device according to any one of the foregoing embodiments. The spraying device is configured to spray water mist or an air-water mixture into the pool.

### BRIEF DESCRIPTION OF THE DRAWINGS

FIG. 1 is a schematic structural diagram of a spraying device according to an embodiment of the present disclosure.

FIG. 2 is an exploded view of the spraying device shown in FIG. 1.

FIG. 3 is a schematic structural diagram of the spraying device shown in FIG. 1 from another perspective.

FIG. 4 is a sectional view taken along A-A in FIG. 3.

FIG. 5 is an enlarged view of B in FIG. 4.

FIG. 6 is a schematic structural diagram of the spraying device shown in FIG. 1 from yet another perspective.

FIG. 7 is a schematic structural diagram of the spraying device shown in FIG. 6 without a spraying lid.

FIG. 8 is a schematic structural diagram of a dust cover of the spraying device shown in FIG. 2.

FIG. 9 is a schematic structural diagram of a mounting support of the spraying device shown in FIG. 2.

FIG. 10 is a schematic structural diagram of an inlet valve of the spraying device shown in FIG. 2.

### REFERENCE SIGNS

10: spraying device; 100: spraying main body; 110: first shell portion; 111: water inlet; 120: second shell portion; 121: mounting cavity; 122: spraying port; 123: air inlet; 124: mounting protrusion; 125: first external thread; 126: first sealing boss; 200: Venturi tube; 210: first tube section; 211: shrink tube portion; 212: throat portion; 213: first opening; 214: mounting boss; 220: second tube section; 221: second opening; 223: air vent; 300: inlet assembly; 310: inlet valve; 311: main body portion; 312: first fixed protrusion; 313: second fixed protrusion; 320: dust cover; 321: fan-shaped strip; 322: arc-shaped baffle; 323: first vent hole; 324: mounting hole; 330: mounting support; 331: limiting protrusion; 332: fixed boss; 333: through hole; 334: second vent hole; 400: spraying cover; 410: spraying hole; 420: first internal thread; 430: second sealing boss; 431: second external thread; 500: spraying lid; 510: second internal thread; 610: first sealing element; 620: second sealing element; 621: communication hole; 630: third sealing element; and 640: gasket.

### DETAILED DESCRIPTION OF THE EMBODIMENTS

In order to make the objectives, technical solutions, and advantages of the present disclosure clearer, the present disclosure is described in further detail below with reference to the accompanying drawings and specific implementations. It should be understood that the specific implementations described herein are intended only to interpret the present disclosure and do not limit the protection scope of the present disclosure.

It should be noted that when an element is referred to as “fixed to” another element, it may be directly disposed on the another element or an intermediate element may exist. When one element is considered to be “connected to” another element, it may be directly connected to the another element or an intermediate element may co-exist. The terms “vertical”, “horizontal”, “left”, “right” and similar expressions used herein are for illustrative purposes only, and are not meant to be unique implementations.

Unless defined otherwise, all technical and scientific terms used herein have the same meanings as would generally understood by those skilled in the technical field of the present disclosure. The terms used in the specification of the present disclosure are for the purpose of describing specific implementations only, and are not intended to limit the present disclosure. The term “and/or” used herein includes any and all combinations of one or more related listed items.

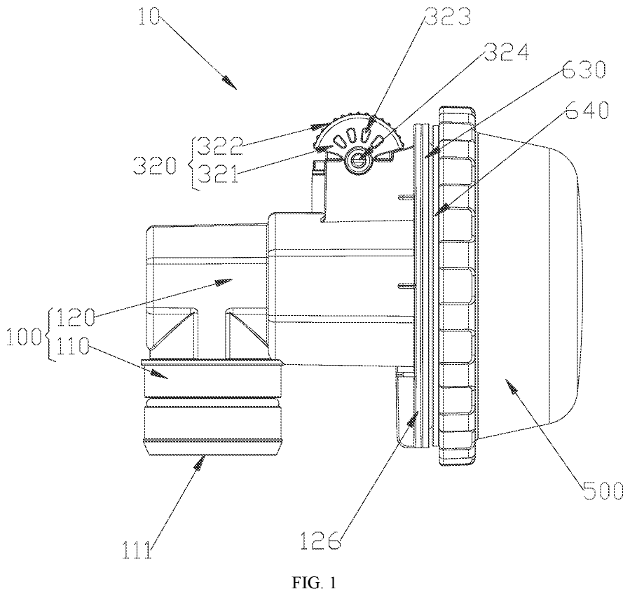

As shown in FIG. 1, an embodiment of the present disclosure provides a pool including a pool body (not shown in the figure) and a spraying device 10. The spraying device 10 is configured to be mounted on a pool wall of the pool body and spray water mist or an air-water mixture with a relatively high flow rate into the pool body, so as to provide a user with a variety of water playing experience and an impact massage effect, which can increase oxygen content of pool water and improve purity of the water at the same time, making a filtration circulation effect of the water more obvious.

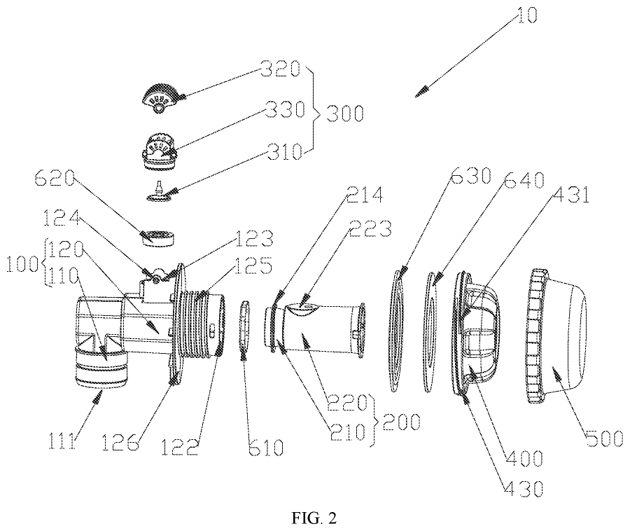

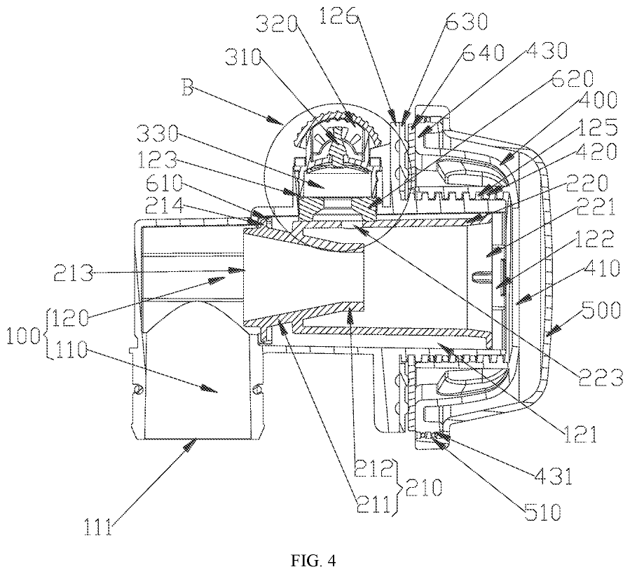

Specifically, as shown in FIG. 1 and FIG. 2, the spraying device 10 includes a spraying main body 100, a Venturi tube 200, an inlet assembly 300, a spraying cover 400, and a spraying lid 500. The spraying main body 100 is roughly of a shell-like structure, specifically including a first shell portion 110 and a second shell portion 120 communicated with each other. The first shell portion 110 and the second shell portion 120 are arranged approximately vertically. An end of the first shell portion 110 away from the second shell portion 120 is provided with a water inlet 111. A mounting cavity 121 (as shown in FIG. 4) that can be communicated with the water inlet 111 is formed in the second shell portion 120. An end of the second shell portion 120 away from the first shell portion 110 is provided with a spraying port 122 that can be communicated with the mounting cavity 121. A roughly middle part of the second shell portion 120 is provided with an air inlet 123 that can be communicated with the mounting cavity 121. In this embodiment, the first shell portion 110 and the second shell portion 120 are arranged approximately vertically mainly to facilitate arrangement of a water pipe connected to a water supply. In other embodiments, an angle between the first shell portion 110 and the second shell portion 120 may also be adjusted according to an actual requirement, or the spraying main body 100 may alternatively include only the second shell portion 120. That is, the first shell portion 110 is not provided. The water inlet 111 is directly arranged at an end of the spraying main body 100 away from the spraying port 122. The Venturi tube 200 is inserted and mounted in the mounting cavity 121, the inlet assembly 300 is mounted at the air inlet 123, the spraying cover 400 detachably or non-detachably covers the spraying port 122 of the spraying main body 100, and the spraying lid 500 detachably covers the spraying cover 400.

Specifically, as shown in FIG. 2 and FIG. 4, the Venturi tube 200 includes a first tube section 210 and a second tube section 220. The first tube section 210 includes a shrink tube portion 211 and a throat portion 212 connected to and communicated with each other, an end of the shrink tube portion 211 away from the throat portion 212 is provided with the first opening 213, and an inner diameter of the shrink tube portion 211 gradually decreases from the first opening 213 to the throat portion 212. An outer wall ring of a shrink tube is provided with a mounting boss 214. The mounting boss 214 is sealed with the inner wall of the mounting cavity 121 through the first sealing element 610 to prevent leakage of the water flow entering the mounting cavity 121 from the water inlet 111 through a gap between a cavity wall of the mounting cavity 121 and an outer wall of the Venturi tube 200. The second tube section 220 is a straight round tube with an inner diameter larger than that of the throat portion 212. An end of the second tube section 220 is provided with the second opening 221, an end of the second tube section 220 away from the second opening 221 is provided with a mounting port (not marked in the figure), an end of the first tube section 210 having the throat portion 212 is inserted into and fixed to the second tube section 220, and the first tube section 210 is communicated with the second tube section 220 through the throat portion 212. In this embodiment, in order to facilitate mounting and fit, an outer diameter of the second tube section 220 is slightly greater than that of the first tube section 210 at the first opening 213. Certainly, in other embodiments, alternatively, the outer diameter of the second tube section 220 may be the same as that of the first tube section 210 at the first opening 213, or the outer diameter of the second tube section 220 may be less than that of the first tube section 210 at the first opening 213. A sidewall of the second tube section 220 is provided with the air vent 223.

In this embodiment, the second tube section 220 is arranged as a straight round tube with an inner diameter greater than that of the throat portion 212 to facilitate opposite arrangement of the air vent 223 and the air inlet 123. Certainly, in other embodiments, alternatively, the second tube section 220 may be a pipeline in another shape, which may be, for example, a diffusion tube section (not shown in the figure) connected to and communicated with the throat portion 212. A tube diameter of the diffusion tube section gradually increases from the throat portion 212 to the second opening 221. A sidewall of the diffusion tube section close to the throat portion 212 is provided with the air vent 223. The air vent 223 may be communicated with the air inlet 123 through a ventilation channel (not shown in the figure).

Further, as shown in FIG. 4, the first opening 213 is communicated with the water inlet 111, the second opening 221 is communicated with the spraying port 122, and the air vent 223 is communicated with the air inlet 123. In this way, when the spraying device 10 is in use, water from the water supply enters the mounting cavity 121 through the water inlet 111 and enters the shrink tube portion 211 through the first opening 213. A water flow moves along a direction from the first opening 213 to the second opening 221. As the tube diameter through which the water flow flows shrinks, according to Bernoulli's equation, a velocity of the water flow may increase continuously and eventually reach a maximum value at the throat portion 212 with a minimum tube diameter. Then, the water flow forms negative pressure at a position of the throat portion 212 away from the shrink tube portion 211, and the outside air then enters the second tube section 220 through the air inlet 123 and the air vent 223 under the negative pressure, thereby being mixed with the water flow. The water flow coming out of the throat portion 212 is sprayed out from the spraying port 122 in a form of a jet of water mist or another air-water mixture due to a sudden increase in the tube diameter and the mixing with the air. Optionally, the air vent 223 is arranged corresponding to the throat portion 212 or the air vent 223 is arranged corresponding to a part between the throat portion 212 and the second opening 221 of the Venturi tube 200. In this embodiment, the air vent 223 is arranged corresponding to the throat portion 212 to obtain a better atomization effect.

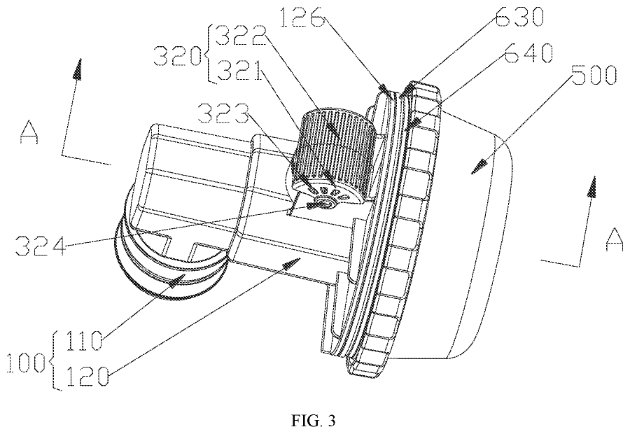

Specifically, as shown in FIG. 3 to FIG. 5, the inlet assembly 300 includes an inlet valve 310, a dust cover 320, and a mounting support 330.

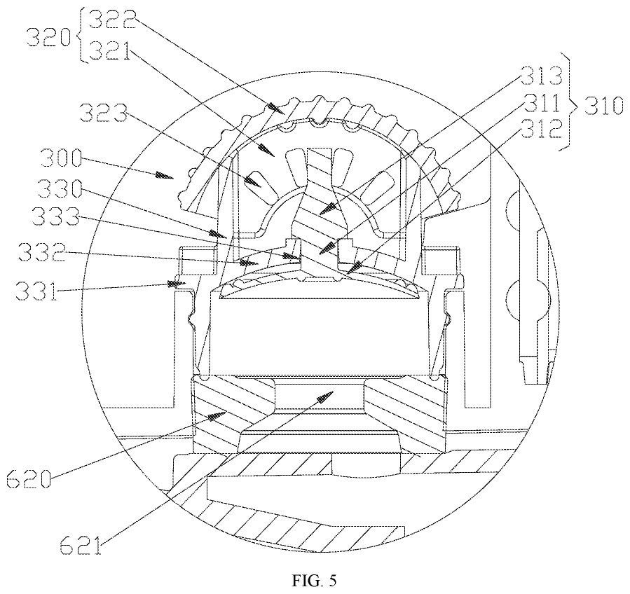

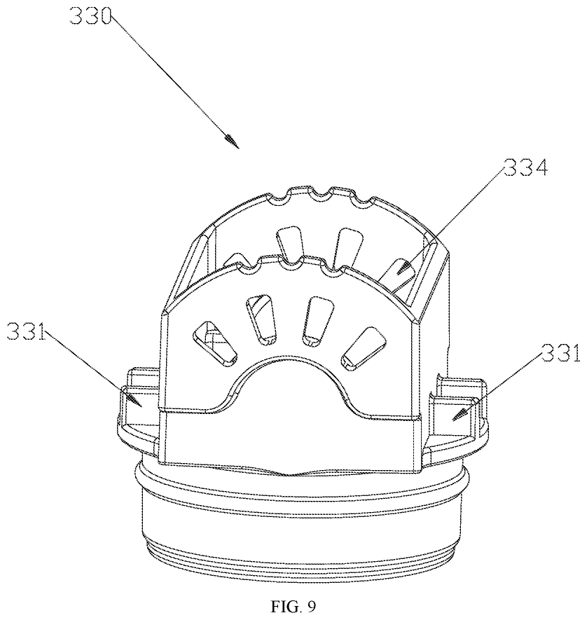

As shown in FIG. 5 and FIG. 9, the mounting support 330 is roughly of a hollow tubular structure, and the hollow tubular structure has an end communicated with the air vent 223 and the other end communicated with external atmosphere. In this embodiment, the mounting support 330 is at least partially inserted into the air inlet 123. An outer wall of the mounting support 330 is provided with two limiting protrusions 331 arranged corresponding to each other. When the mounting support 330 is partially inserted into the air inlet 123, the limiting protrusions 331 abut against a wall of the air inlet 123 to prevent falling of the mounting support 330 into the mounting cavity 121. The mounting support 330 is provided with an annular fixed boss 332, and a through hole 333 is arranged in the middle of the fixed boss 332. Certainly, in other embodiments, the limiting protrusions 331 may also be omitted, and the outer wall of the mounting support 330 may be fixed to the air inlet in another manner such as interference fit.

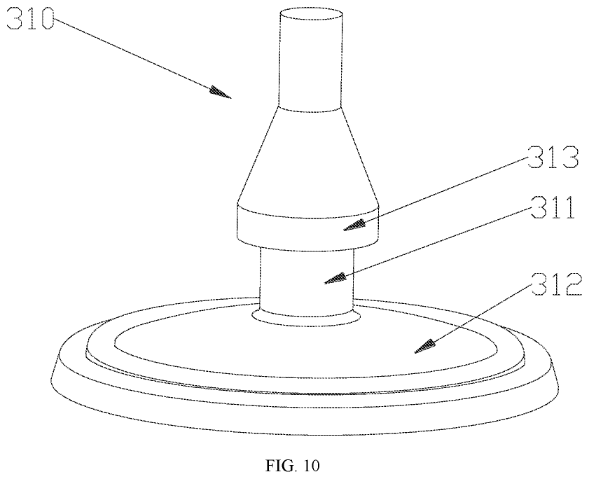

As shown in FIG. 5 and FIG. 10, the inlet valve 310 is made of a rubber material, the inlet valve 310 includes a main body portion 311 and a first fixed protrusion 312 and a second fixed protrusion 313 that are convexly arranged outside the main body portion 311, and a radial size of the first fixed protrusion 312 is greater than that of the second fixed protrusion 313. When the inlet valve 310 is fixed to the mounting support 330, the first fixed protrusion 312 is located on one side of the fixed boss 332 facing the air vent 223, and the second fixed protrusion 313 is located on one side of the fixed boss 332 facing away from the air vent 223. The outside air can enter the air inlet 123 and the air vent 223 through a gap between the inlet valve 310 and the mounting support 330. In this embodiment, through the inlet valve 310, outflow of the water in the Venturi tube 200 from the air inlet 123 can be prevented, and at the same time, the outside air can be allowed to enter the Venturi tube 200 through the air inlet 123.

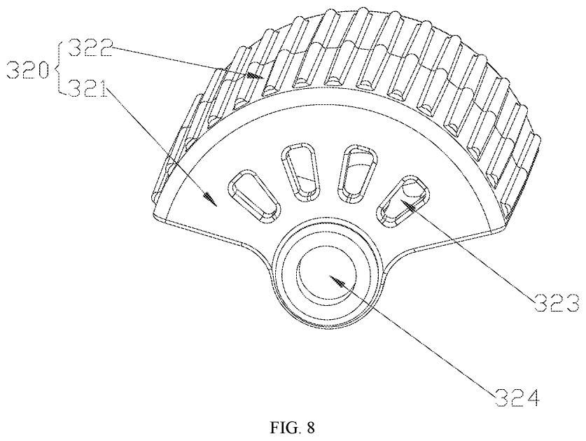

Further, as shown in FIG. 5 and FIG. 8, the dust cover 320 is configured to cover an end of the mounting support 330 away from the air vent 223. The dust cover 320 has a fan-shaped cover structure, specifically including two fan-shaped strips 321 arranged corresponding to each other and an arc-shaped baffle 322 connected between the fan-shaped strips 321. Each fan-shaped strip is provided with a plurality of first vent holes 323, and a plurality of second vent holes 334 (as shown in FIG. 9) are arranged at a corresponding position of the mounting support 330. When the dust cover 320 covers the mounting support 330, the first vent hole 323 is corresponding to the second vent hole 334 to ensure circulation of the air, and the arc-shaped baffle 322 is arranged at the air inlet 123 to prevent falling of dust and other dirt into the mounting cavity 121. In this embodiment, each fan-shaped strip 321 is provided with a mounting hole 324, a mounting protrusion 124 (as shown in FIG. 2) is correspondingly arranged on the wall of the air inlet 123, the dust cover 320 covers the air inlet 123, and the mounting protrusion 124 is inserted into and fits the mounting hole 324 to fix the dust cover 320 to the spraying main body 100. In other embodiments, the arrangement may also be reversed. The fan-shaped strip 321 is provided with the mounting protrusion 124, the wall of the air inlet 123 is provided with the mounting hole 324, or the fan-shaped strip 321 and the wall of the air inlet 123 are each provided with the mounting hole 324, and the dust cover 320 is fixed to the spraying main body 100 by passing through the mounting holes 324 on the fan-shaped strip 321 and the wall of the air inlet 123 through fasteners such as pins.

Certainly, in other embodiments, the dust cover 320 may alternatively have another shape and structure, such as a bell shape. Numbers of the first vent hole 323 and the second vent hole 334 communicated with each other may be adjusted through adjustment of a relative position between the dust cover 320 and the mounting support 330, or adjustment of a relative position between the mounting support 330 and the mounting cavity 121, or adjustment of a relative position between the dust cover 320 and the mounting cavity 121, thereby adjusting an amount of air intake.

Further, as shown in FIG. 2 and FIG. 5, the air inlet 123 is also provided with a second sealing element 620. The second sealing element 620 may be a sealing ring made of a rubber material. Two ends of the second sealing element 620 abut against the bottom of the mounting support 330 and the top of the Venturi tube 200 respectively. The second sealing element 620 can prevent leakage of water through a gap between the cavity wall of the mounting cavity 121 (i.e., the wall of the air inlet 123) and the mounting support 330. In this embodiment, a roughly middle part of the second sealing element 620 is provided with a communication hole 621, and due to deviation of central positions of the air vent 223 and the air inlet 123, an opening diameter of the communication hole 621 gradually increases in a direction close to the Venturi tube 200. Certainly, when the central positions of the air vent 223 and the air inlet 123 do not deviate, the opening diameter of the communication hole 621 may also be kept equal everywhere. That is, the communication hole 621 may be, for example, a straight round hole, or the like.

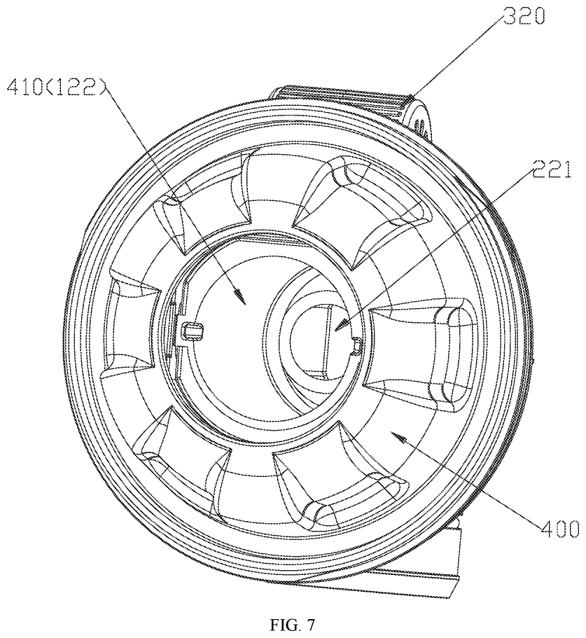

Further, as shown in FIG. 2 and FIG. 7, the spraying cover 400 is roughly of a bell-shaped structure and is configured to cover the spraying port 122. The spraying cover 400 is provided with at least one spraying hole 410 for the air-water mixture (or water mist) flowing through the spraying port 122 to be sprayed out. Specifically, a number and a distribution position of the spraying hole 410 may be set according to a required spraying effect. For example, a plurality of spraying holes 410 may be set to pedal-shaped or wave-shaped arrangement, or the like. The spraying cover 400 is detachably connected to the spraying main body 100 so as to mount the spraying device 10 onto the pool body. Specifically, the spraying cover 400 is removed from the spraying main body 100, so that a pool wall of the pool body is sandwiched between the spraying cover 400 and the spraying main body 100, the spraying cover 400 is fastened to the spraying main body 100, and the spraying device 10 can be fixed to the pool wall. Specifically, as shown in FIG. 4, the spraying cover 400 and the spraying main body 100 may be connected by thread. For example, a first external thread 125 may be arranged on an outer wall of the spraying main body 100 (specifically the second shell portion 120) close to the spraying port 122, a first internal thread 420 that can be screwed with the first external thread 125 may be arranged on an inner wall of the spraying cover 400, and so on. Certainly, the spraying cover 400 and the spraying main body 100 may alternatively be detachably connected in other manners, such as through clamping and fastener connection. In other embodiments, the spraying cover 400 and the spraying main body 100 may alternatively be fixedly connected.

Further, as shown in FIG. 2, a third sealing element 630 is further arranged between the spraying main body 100 and the spraying cover 400 to prevent leakage of the water flow or air-water mixture from a gap between the spraying main body 100 and the spraying cover 400. In this embodiment, the third sealing element 630 is a gasket. A gasket 640 is further provided between the spraying main body 100 and the spraying cover 400 to assist the third sealing element 630 to further improve a sealing effect. Specifically, a first sealing boss 126 is annularly arranged on the outer wall of the spraying main body 100 (specifically the second shell portion 120), and the first sealing boss 126 is arranged on one side of the first external thread 125 away from the spraying port 122. A second sealing boss 430 is annularly arranged on an outer wall of the spraying cover 400. When the spraying cover 400 is connected to the spraying main body 100 by thread, the first sealing boss 126, the third sealing element 630, the gasket 640, and the second sealing boss 430 abut against one another sequentially. Certainly, in other embodiments, if the sealing effect of the third sealing element 630 can meet a requirement, the gasket 640 may alternatively be omitted.

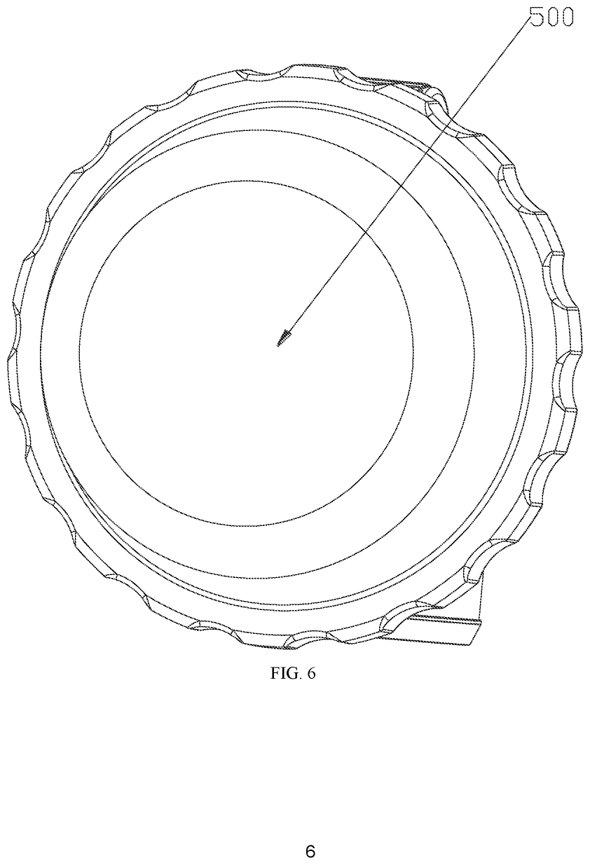

Further, as shown in FIG. 2 and FIG. 6, the spraying lid 500 is roughly of a bell-shaped structure and is configured to detachably cover the spraying cover 400. In this way, when the spraying device 10 is not in use, or there is a need to temporarily prevent outflow of pool water due to replacement of a filter element or bellow, the spraying lid 500 may cover the spraying cover 400 to prevent entry of foreign matters into the spraying device 10 or prevent the outflow of the pool water. Specifically, as shown in FIG. 4, the spraying lid 500 and the spraying cover 400 may be connected by thread. For example, a second external thread 431 may be arranged outside the second sealing boss 430, and a second internal thread 510 that can be screwed with the second external thread 431 may be arranged on an inner wall of the spraying lid 500. Certainly, the spraying cover 400 and the spraying lid 500 may alternatively be detachably connected in other manners, such as through clamping and fastener connection.

The above spraying device 10 and the pool have at least the following technical effects.

When the above spraying device 10 is in use, water may be introduced into the Venturi tube 200 through the first opening 213, and a water flow flows along a direction from the first opening 213 to the second opening 221. Moreover, when the water flow flows through the throat portion 212, it has an increased flow velocity since the tube diameter shrinks. As a result, the water flow forms a negative pressure near the throat portion 212, so that the outside air enters the Venturi tube 200 through the air vent 223 under the negative pressure, is mixed with the water flow, and continues to flow to the second opening 221. Since the opening diameter of the second opening 221 is greater than the tube diameter of the throat portion 212, a water-air mixture is finally sprayed out of the second opening 221 in a shape of a high-speed jet, so as to form water mist with a better atomization effect or an air-water mixture with a higher flow rate in the pool body to provide a user with a variety of water playing experience and an impact massage effect, which can increase oxygen content of pool water and improve purity of the water at the same time, making a filtration circulation effect of the water more obvious. At the same time, the faster flow of the water in the throat portion 212 can also prevent formation of scale in the Venturi tube 200 to some extent.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A spraying device, comprising:
a Venturi tube, two ends of the Venturi tube being provided with a first opening and a second opening respectively, a sidewall of the Venturi tube being provided with an air vent, the Venturi tube having a throat portion arranged between the first opening and the second opening, a tube diameter of the throat portion being less than an opening diameter of the first opening and less than an opening diameter of the second opening;
wherein the first opening is used for communicating with a water supply, and the air vent is used for communicating with external atmosphere.

2. The spraying device according to claim 1, wherein the air vent is arranged corresponding to the throat portion or the air vent is arranged corresponding to a part of the Venturi tube between the throat portion and the second opening.

3. The spraying device according to claim 2, wherein the Venturi tube further comprises a shrink tube portion communicated with the throat portion, an end of the shrink tube portion away from the throat portion being provided with the first opening.

4. The spraying device according to claim 1, wherein the Venturi tube comprises:
a first tube section comprising a shrink tube portion and a throat portion connected with each other, an end of the shrink tube portion away from the throat portion being provided with the first opening, an inner diameter of the shrink tube portion gradually decreasing from the first opening to the throat portion; and
a second tube section, an inner diameter of the second tube section being greater than that of the throat portion, an end of the second tube section being provided with the second opening, a sidewall of the second tube section being provided with the air vent, an end of the second tube section away from the second opening being provided with a mounting port;
wherein an end of the first tube section having the throat portion is inserted into and fixed to the second tube section, and the first tube section is communicated with the second tube section through the throat portion.

5. The spraying device according to claim 1, further comprising:
a spraying main body having an air inlet, a water inlet, a spraying port, and a mounting cavity, the air inlet, the water inlet, and the spraying port being all communicated with the mounting cavity;
wherein the Venturi tube is arranged in the mounting cavity, the water inlet is communicated with the water supply and the first opening, the air inlet is communicated with the external atmosphere and the air vent, and the spraying port is communicated with the second opening.

6. The spraying device according to claim 5, further comprising a first sealing element, the first sealing element being arranged between a cavity wall of the mounting cavity and an outer wall of the Venturi tube.

7. The spraying device according to claim 5, further comprising an inlet valve arranged at the air inlet to prevent outflow of water in the Venturi tube through the air inlet.

8. The spraying device according to claim 5, further comprising a dust cover arranged at the air inlet to prevent entry of dust into the spraying main body through the air inlet.

9. The spraying device according to claim 5, further comprising an inlet valve and a mounting support, the mounting support being of a hollow tubular structure, an end of the hollow tubular structure being communicated with the air vent, the inlet valve being arranged in the hollow tubular structure to prevent outflow of water in the Venturi tube through the air inlet.

10. The spraying device according to claim 9, further comprising a dust cover arranged at an end of the hollow tubular structure away from the air vent.

11. The spraying device according to claim 9, further comprising a second sealing element arranged between the mounting support and the Venturi tube.

12. The spraying device according to claim 5, further comprising a spraying cover provided with at least one spraying hole, the spraying cover covering the spraying port.

13. The spraying device according to claim 12, wherein the spraying cover is detachably connected to the spraying main body.

14. The spraying device according to claim 13, further comprising a third sealing element arranged between the spraying cover and the spraying main body.

15. The spraying device according to claim 12, further comprising a spraying lid configured to detachably cover the spraying cover.

16. A pool, comprising a pool body and the spraying device according claim 1, the spraying device being configured to spray water mist or an air-water mixture into the pool.
